(19) United States
(12) Patent Application Publication
(10) Pub. No.: US 2006/0028167 A1
(43) Pub. Date: Feb. 9, 2006

(54) ENERGY MANAGEMENT SYSTEM AND METHOD

(75) Inventors: John Czubay, Troy, MI (US); John Proietty, Ferndale, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/161,035

(22) Filed: Jul. 20, 2005

Related U.S. Application Data
(60) Provisional application No. 60/590,749, filed on Jul. 23, 2004.

(51) Int. Cl. H02J 7/00

(52) U.S. Cl. 320/104

(57) ABSTRACT

A system and method for efficient management of energy within a vehicle wherein the vehicle includes a battery and a motor. The method comprises generating electrical energy through the use of the motor and determining the battery temperature and the battery's state of charge. The method further includes applying electrical energy from the motor to the battery to simultaneously charge and heat the battery when the battery's state of charge is less than a predetermined battery charge limit and the battery temperature is greater than a lower charge efficiency temperature.

### CROSS-REFERENCE TO RELATED APPLICATIONS

This application claims the benefit of U.S. provisional application Ser. No. 60/590,749 filed Jul. 23, 2004, entitled “METHOD FOR MANAGING REGENERATIVE BRAKING ENERGY FOR CHARGING AND HEATING THE BATTERY PACK IN AN EV, HEV, FCEV,” the entire contents of which is hereby incorporated by reference.

### TECHNICAL FIELD

The present invention relates to a system and method for charging and heating a battery within a vehicle.

### BACKGROUND

As commonly known, rechargeable batteries have been used for electrical energy storage in a wide range of vehicle applications. In the case of vehicles having regenerative braking, the application of the brakes by a vehicle operator causes energy, that would otherwise be lost as heat, to be fed into a battery for recharging. Once the vehicle begins accelerating again the battery may be utilized as a power source to aid vehicle acceleration. However, it is known that battery performance is affected by the battery's internal and ambient temperatures. Particularly in cold climates, the battery's ability to accept a charge becomes increasingly more difficult as the temperature decreases. As a result, the vehicle suffers from a diminished recovery of braking energy in cold climates. Additionally, in a cold temperature environment, the ability of the battery to supply power to various vehicle systems and/or components is negatively impacted. In the case of electric vehicles, hybrid electric vehicles, and fuel cell electric vehicles, insufficient battery performance is of even greater importance in that the battery in such vehicles may be utilized as a primary energy source to enable motive force. In such applications, to improve the battery performance in these vehicles, the battery's temperature must be elevated to within an acceptable operating temperature range.

Accordingly, in some conventional systems, designers have incorporated battery heaters and/or developed systems that are capable of applying electric current to the battery thereby elevating the battery temperature. However, these systems have several disadvantages. For instance, these systems are incapable of adequately proportioning energy within the system for charging the battery and heating the battery. Additionally, with the conventional systems, energy produced through the use of a regenerative braking system is not optimally proportioned to heat and/or charge the battery within an acceptable period of time.

The present invention was conceived in view of these and other disadvantages of conventional vehicle energy management systems. It improves the overall vehicle efficiency i.e. fuel economy, by allowing the battery to be used sooner in the drive cycle in colder climates as it utilizes the braking energy that would otherwise be dissipated as heat in the friction brakes. It also has the benefit of improving the overall life of the friction brakes.

### SUMMARY

The present invention discloses a system and method for efficient management of energy within a vehicle wherein the vehicle includes a battery and a motor. The method comprises generating electrical energy through the use of the motor and determining the battery charge limit, which is a function of battery state of charge, battery temperature and total regenerative energy available. The method further includes applying electrical energy from the motor to the battery to simultaneously charge and heat the battery when the total regenerative energy available is greater than the battery charge limit and the battery temperature is greater than a lower charge efficiency temperature but less than an upper charge efficiency temperature. The method further discloses applying electrical energy from the motor to the battery to heat the battery when the battery temperature is less than a lower charge efficiency temperature. Additionally, the method includes applying electrical energy from the motor to the battery to charge the battery when the battery temperature is greater than the upper charge efficiency temperature.

An energy management system is also provided which includes a battery configured to receive electrical energy and a motor capable of generating electrical energy. The energy management system further includes an energy management device that is operable with the battery and motor and configured to determine the battery temperature and battery state of charge. The energy management device is also configured to generate signals based on the determined battery charge limit, which is a function of battery state of charge, battery temperature and total regenerative energy available to effect simultaneous charging and heating of the battery. The energy management device also generates signals for simultaneous charging and heating of the battery when the total regenerative energy available is greater than the battery charge limit and the battery temperature is greater than a lower charge efficiency temperature but also less than an upper charge efficiency temperature. The system property further includes the energy management device being capable of generating signals for heating of the battery when the battery temperature is less than a lower charge efficiency temperature.

### BRIEF DESCRIPTION OF THE DRAWINGS

These and other features and advantages of the invention will be apparent from the following detailed description and the appendant claims, taken in conjunction with the accompanying drawings, in which:

FIG. 1 illustrates a vehicle having a regenerative braking system configured to efficiently proportion recovered energy for charging and/or heating of a battery according to an embodiment of the present invention;

FIG. 2 is a chart illustrating total regenerative energy available and battery charge limit versus battery temperature; and

FIG. 3 illustrates a flow diagram of a methodology for efficiently proportioning regenerative braking energy for charging and/or heating a battery in accordance with an embodiment of the present invention.

### DETAILED DESCRIPTION OF THE PREFERRED EMBODIMENT(S)

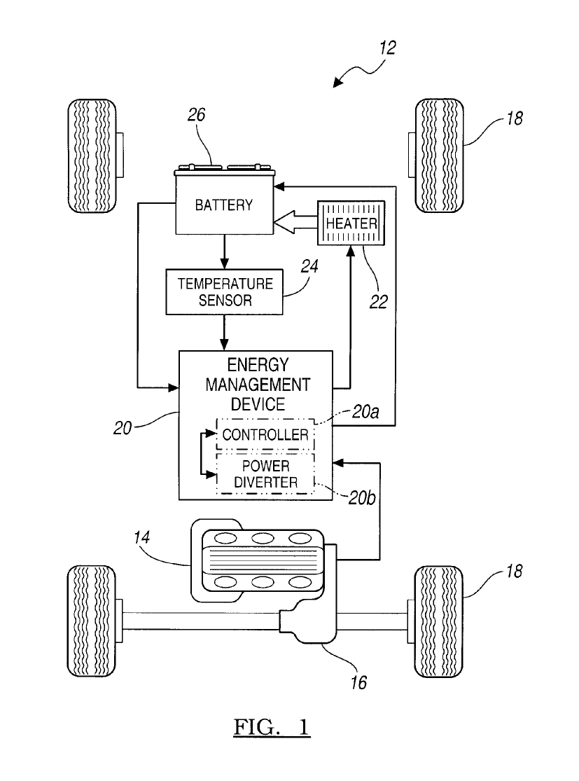

Referring to FIG. 1, a vehicle 12 having a regenerative braking system is illustrated. Vehicle 12 includes an engine 14 that is coupled to a motor/generator 16. As shown, motor 16 is mechanically coupled to wheels 18. The motor 16 is configured to apply motor force to wheels 18. Additionally, motor 16 is configured to transform mechanical energy into electrical energy during a braking event and supply that electrical energy to a battery 26 for storage. Vehicle 12 further includes an energy management device 20 that communicates with motor 16. Energy management device 20 is also adapted to communicate with a heater device 22, a temperature sensor 24 and battery 26. Energy management device 20 may include a controller 20a having memory storage and data processing capabilities. Energy management device 20 may also include a power diverting device 20b for diverting electrical energy produced by motor 16 to heater 22 and/or battery 26. Power diverting device 20b may include a power transistor configuration to receive an electrical signal and divert the received signal in accordance with a control signal generated by controller 20a. In some embodiments, temperature sensor 24 may be integrated with energy management device 20.

It is recognized that vehicle 12 may be an electric vehicle, hybrid electric vehicle, or a fuel cell electric vehicle having regenerative braking functionality. Accordingly, energy management device 20 is adapted to process signals from motor 16 and temperature sensor 24 for determination of the charging and/or heating requirements of battery 26. In some embodiments, battery 26 may be a lead-acid type battery, a nickel metal hydride type battery, or a lithium-ion type battery. In either embodiment, vehicle 12, through the use of energy management device 20, heater 22, and temperature sensor 24 is configured to determine the temperature and battery charge limit of battery 26. Accordingly, upon determination of the battery temperature, battery charge limit and total regenerative energy available of battery 26, energy management device 20 is capable of diverting electrical energy produced by motor 16 to battery 26 for charging and/or heater 22 for heating the battery.

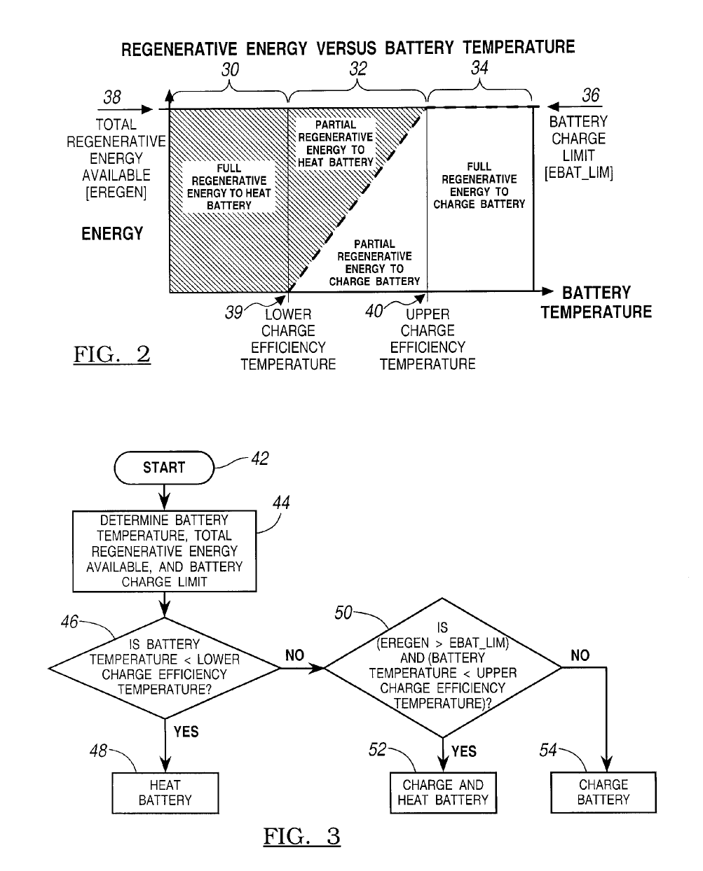

Now referring to FIG. 2, a chart illustrating total regenerative energy available and battery charge limit versus battery temperature is shown. As indicated by brackets 30, 32, and 34 the operating temperature for battery 26 may be partitioned into various charging and/or heating modes. Additionally, FIG. 2 illustrates the total regenerative energy available (Eregen) 38 from motor 16 and a battery charge limit (Ebat_lim) 36. Battery charge limit 36 indicates an upper limit to which battery 26 (FIG. 1) may be charged. In one embodiment, the battery charge limit is about 400 volts.

A heating mode is indicated by bracket 30 wherein Eregen 38 is diverted by energy management device 20 to heater 22 for heating of battery 26. A partial heating and charging mode is indicated by bracket 32 wherein energy management device 20 diverts electrical energy produced by motor 26 to heater 22 for heating of battery 26 and to battery 26 for charging. Accordingly, the electrical energy from motor 16 is proportioned to simultaneous charge and heat battery 26. A charging mode is indicated by bracket 34 wherein energy management device 20 diverts electrical energy produced by motor 16 to battery 26 for charging.

As shown in FIG. 2, modes 30, 32, and 34 are partitioned by predetermined thresholds such as a lower charge efficiency temperature 39 and an upper charge efficiency temperature 40. The lower charge efficiency temperature 39 and upper charge efficiency temperature 40 may vary in magnitude depending upon the particular implementation of battery 26. Nevertheless, energy management device 20 is programmed with lower charge efficiency temperature 39 and upper charge efficiency temperature 40 in accordance with the particular embodiment of battery 26. Lower charge efficiency temperature 39 may be described as the minimum temperature to allow simultaneous heating and charging of battery 26. Upper charge efficiency temperature 40 may be described as the maximum temperature to allow charging and heating of battery 26. As will be described hereinafter, energy management device 20 is configured to process data and signals received to adequately proportion electrical energy produced by motor 16 in accordance with heating mode 30, heating and charging mode 32, and charging mode 34 as illustrated in FIG. 2.

Referring to FIG. 3, a flow diagram of a methodology for efficient proportioning of electrical energy produced by motor 16 is illustrated. Accordingly, the step 42 is the entry point into the methodology. A step 44 includes determining the battery temperature, the total regenerative energy available, and the battery charge limit.

As described in the foregoing, energy management device 20 is configured to receive and process signals from temperature sensor 24, motor 16 and battery 26 for determining the battery temperature, the total regenerative energy available, and the battery charge limit. As such, at a step 46, the method determines whether the battery temperature is less than the lower charge efficiency temperature. When the battery temperature is less than the lower charge efficiency temperature, electrical energy from the motor is diverted to heater 22, which generates heat that is applied to battery 26 as indicated by block 48. If the battery temperature is greater than the lower efficiency temperature, a step 50 occurs wherein the method determines whether the total regenerative energy available is greater than the battery charge limit and whether the battery temperature is less than the upper charge efficiency temperature. If the total regenerative energy available is greater than the battery charge limit and the battery temperature is less than the upper charge efficiency temperature, a step 52 occurs wherein the battery is simultaneously charged and heated. Where either the total regenerative energy available is less than the battery charge limit or the battery temperature is greater than the upper charge efficiency temperature, a step 54 occurs where electrical energy produced by the motor is directed to the battery for charging.

Accordingly, the performance of the battery is improved as regenerative braking energy is optimally proportioned to heat and/or charge the battery pack within an optimal time period. Also, overall vehicle efficiency is maximized as the energy that would otherwise be dissipated as heat in a conventional friction brake system is recovered through the use of the regenerative braking system, and is used as a power source to provide charging and/or heating for the battery.

While the best mode for carrying out the invention has been described in detail, those familiar with the art to which this invention relates will recognize various alternative designs and embodiments, and equivalents thereof for practicing the invention as defined by the following claims.

What is claimed is:

1. A method of managing energy for a vehicle having a battery and a motor, the method comprising:
generating electrical energy through the use of the motor;
determining a battery temperature, a battery charge limit and a total regenerative energy available; and
applying electrical energy from the motor to the battery to simultaneously charge and heat the battery when the total regenerative energy available is greater than the battery charge limit and the battery temperature is greater than a lower charge efficiency temperature.

2. A method according to claim 1, further comprising applying electrical energy from the motor to the battery to simultaneously charge and heat the battery when the battery temperature is less than an upper charge efficiency temperature.

3. A method according to claim 2, wherein applying electrical energy from the motor to the battery to simultaneously charge and heat the battery occurs by diverting the electrical energy from the motor to a heater device that generates heat that is applied to the battery and diverting electrical energy from the motor to the battery for charging.

4. A method according to claim 1, further comprising:
applying electrical energy from the motor to the battery to heat the battery when the battery temperature is less than a lower charge efficiency temperature and
applying electrical energy from the motor to the battery to charge the battery when the total regenerative energy available is less than the battery charge limit or the battery temperature is greater than the upper charge efficiency temperature.

5. A method according to claim 1, wherein determining the battery temperature battery charge limit and total regenerative energy available occurs through the use of an energy management device and a temperature sensor.

6. A method according to claim 1, wherein the energy management device includes a controller.

7. A method according to claim 1, wherein the energy management device includes a power diverting device.

8. An energy management system for a vehicle comprising:
a battery configured to receive electrical energy;
a motor capable of generating electrical energy; and
an energy management device operable with the battery and motor, and configured to determine a battery temperature and a battery state of charge for generating signals based on the determined battery temperature and battery charge limit to effect simultaneous charging and heating of the battery.

9. A system according to claim 8, wherein the energy management device generates signals for simultaneous charging and heating of the battery when the total regenerative energy available is greater than the battery charge limit and the battery temperature is greater than a lower charge efficiency temperature.

10. A system according to claim 8, wherein the energy management device includes a controller and a power diverting device.

11. A system according to claim 8, wherein the energy management device generates signals for simultaneous charging and heating of the battery when the battery temperature is less than an upper charge efficiency temperature.

12. A system according to claim 8, wherein the energy management device generates signals for heating the battery when the battery temperature is less than a lower charge efficiency temperature.

13. A system according to claim 8, wherein the energy management device generates signals to charge the battery when:
the total regenerative energy available is less than the battery charge limit or the battery temperature is greater than an upper charge efficiency temperature.

14. A system according to claim 8, further including a heater device configured to receive the signals generated by the energy management device and generate heat for the battery.

15. A method of managing energy for a vehicle having an energy management device that is configured to determine the battery temperature, battery charge limit and total regenerative energy available, a battery, and a motor comprising:
determining the battery temperature and battery state of charge;
receiving an input torque at the motor;
transforming the input torque into electrical energy through the use of the motor; and
applying electrical energy from the motor to the battery through the use of the energy management device for simultaneous charging and heating of the battery when the total regenerative energy available is greater than the battery charge limit and the battery temperature is greater than a lower charge efficiency temperature but less than an upper charge efficiency temperature.

16. A method according to claim 15, further comprising:
applying electrical energy from the motor to the battery, through the use of the energy management device to heat the battery when the battery temperature is less than a lower charge efficiency temperature; and
applying electrical energy from the motor to the battery to charge the battery when the total regenerative energy available is less than the battery charge limit or the battery temperature is greater than the upper charge efficiency temperature.

17. A method according to claim 15,wherein applying electrical energy from the motor to the battery to simultaneously charge and heat the battery occurs by diverting the electrical energy from the motor to a heater device that generates heat that is applied to the battery and diverting electrical energy from the motor to the battery for charging.

18. A method according to claim 15, wherein determining the battery temperature, battery charge limit and total regenerative energy available occurs through the use of an energy management device and a temperature sensor.

19. A method according to claim 15, wherein the energy management device includes a controller.

20. A method according to claim 15, wherein the energy management device includes a power diverting device.
